(19) United States
(12) Patent Application Publication
(10) Pub. No.: US 2007/0177806 A1
(43) Pub. Date: Aug. 2, 2007

(54) System, device, method and computer program product for using a mobile camera for controlling a computer

(75) Inventor: Panu Vartiainen, Lahti (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/345,437

(22) Filed: Feb. 1, 2006

(51) Int. Cl. G06K 9/46

(52) U.S. Cl. 382/201

(57) ABSTRACT

A system for controlling a computing apparatus includes a mobile camera and a processing device. One of the mobile camera and the processing device is capable of determining a first relationship between a coordinate space of a media surface and a coordinate space of a camera image field at a first point in time, determining a first position of a pointing device relative to the coordinate space of the camera image field at the first point in time, determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field, and controlling a computer application based on the first position of the pointing device relative to the coordinate space of the media surface.

### FIELD OF THE INVENTION

Embodiments of the present invention relate to controlling a device for displaying information. More specifically, embodiments of the present invention relate to controlling a visual display using a mobile camera.

### BACKGROUND OF THE INVENTION

It is common for presenters of information related to business, research, academia, etc., to include a visual display of the information. Many means of providing such a visual display have been developed. Examples of means for providing visual displays include projectors, liquid crystal display (LCD) screens, cathode ray tube (CRT) displays, etc. that are fed the visual information by, for example, a computer. When displaying information visually, it is often desirable to enable the presenter to have control of the display. Often times, in order to grant such control, the presenter may be bound to the computer, or bound to an interface device required for control that is easily lost or not easy to employ. For example, the presenter may be required to use a particular pen that is enabled to interact with the display or a handheld trackball or mouse that wirelessly communicates with either the computer or the media on which the information is displayed. Additionally, such an interface device may require calibration, batteries, or may be usable with only specific other devices. Thus, means for providing visual displays become inflexible and cumbersome.

In order to reduce reliance upon interface devices and improve the flexibility and utility of visual display means, a variety of mechanisms have been developed. Digital white boards and so called “smart” display boards have been developed to allow a presenter to interact with the visual display essentially free of interface devices. Instead a finger, generic pen or pencil may be utilized as a pointing device. Such display boards typically require the presenter to be in close proximity to the display board. Furthermore, implementations have been proposed in which a camera could be used to capture the position of the pointing device relative to a screen and transmit the position to a computer. However, these implementations are often relatively expensive and complex. Moreover, the camera is typically required to be fixed and there is little or no functionality associated with the pointing device.

### BRIEF SUMMARY OF THE INVENTION

A system, terminal, method, and computer program product are therefore provided that enable using a mobile camera for controlling a computer, thereby enabling interactive control of a visual display without being bound to a particular display media.

In an exemplary embodiment, a system for controlling a computing apparatus is provided. The system includes a mobile camera and a processing device. One of the mobile camera and the processing device is capable of determining a first relationship between a coordinate space of a media surface and a coordinate space of a camera image field at a first point in time, determining a first position of a pointing device relative to the coordinate space of the camera image field at the first point in time, determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field, and controlling a computer application based on the first position of the pointing device relative to the coordinate space of the media surface.

In another exemplary embodiment, a method for controlling a computing apparatus is provided. The method includes determining a first relationship between a coordinate space of a media surface and a coordinate space of a camera image field at a first point in time, determining a first position of a pointing device relative to the coordinate space of the camera image field at the first point in time, determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field, and controlling a computer application based on the first position of the pointing device relative to the coordinate space of the media surface.

In another exemplary embodiment, a mobile camera for controlling a computing apparatus is provided. The camera includes a processing element capable of determining a first relationship between a coordinate space of a media surface and a coordinate space of a camera image field at a first point in time, determining a first position of a pointing device relative to the coordinate space of the camera image field at the first point in time, determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field, and controlling a computer application based on the first position of the pointing device relative to the coordinate space of the media surface.

In another exemplary embodiment, a processing device for controlling a computing apparatus is provided. The processing device includes a processing element capable of determining a first relationship between a coordinate space of a media surface and a coordinate space of a camera image field at a first point in time, determining a first position of a pointing device relative to the coordinate space of the camera image field at the first point in time, determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field, and controlling a computer application based on the first position of the pointing device relative to the coordinate space of the media surface.

In yet another exemplary embodiment, a computer program product for controlling a computing apparatus is provided. The computer program product includes at least one computer-readable storage medium having computer-readable program code portions stored therein. The computer-readable program code portions include a first executable portion, a second executable portion, a third executable portion and a fourth executable portion. The first executable portion capable of determining a first relationship between a coordinate space of a media surface and a coordinate space of a camera image field at a first point in time. The second executable portion capable of determining a first position of a pointing device relative to the coordinate space of the camera image field at the first point in time. The third executable portion capable of determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field. The fourth executable portion is capable of controlling a computer application based on the first position of the pointing device relative to the coordinate space of the media surface.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic view of a system that enables using a mobile camera for controlling a computer according to an exemplary embodiment of the present invention; and

FIG. 2 is flowchart illustrating a method for controlling a computer according to an exemplary embodiment of the present invention.

### DETAILED DESCRIPTION OF THE INVENTION

Embodiments of the invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

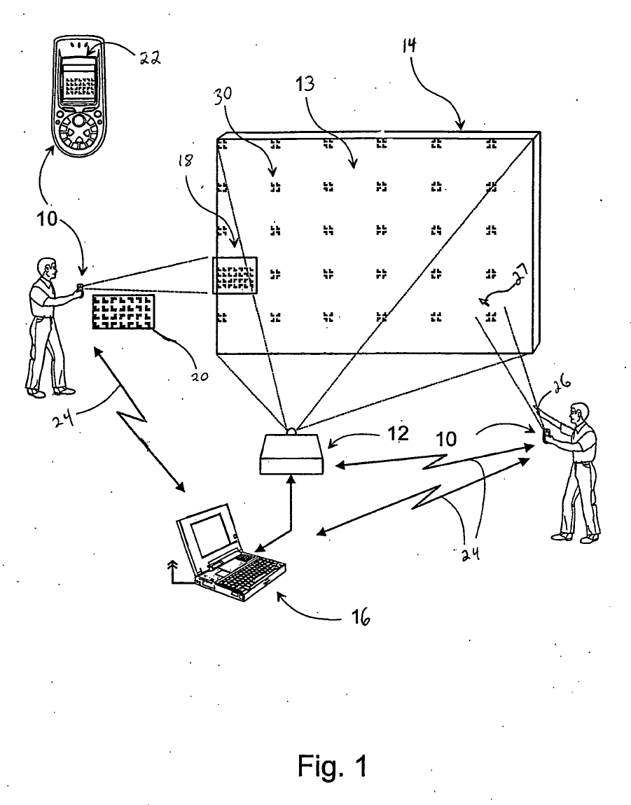

FIG. 1 is a schematic view of a system that enables using a mobile camera for controlling a computer or other computing apparatus according to an exemplary embodiment of the present invention. The system includes a mobile camera 10, a presentation device 12, a presentation media 14 and a processing device 16. The mobile camera 10 may be any camera or other device capable of capturing an image and communicating the image to the processing device 16. In an exemplary embodiment, the mobile camera 10 is part of a mobile terminal such as, for example a mobile phone. The presentation device 12 may be, for example, a video projector, a data projector, etc., that is capable of projecting or displaying a display 13. The presentation media 14 may be virtually any surface including, for example, a wall, a screen, a piece of paper, a desktop, a display, etc. Typically, the surface is planar to avoid undesirable distortion. The processing device 16 may be, for example, a computer apparatus or equivalent device. In an exemplary embodiment, the processing device 16 is a laptop computer.

It should be noted that although FIG. 1 shows the presentation device 12, the presentation media 14 and the processing device 16 as separate entities, all or some of the above listed elements may be embodied in a single entity. For example, a laptop computer having an LCD display may embody each of the presentation device 12, the presentation media 14 and the processing device 16 within a single entity. Furthermore, the mobile camera 10 may be combined with the processing device 16 into a single entity.

As shown in FIG. 1, the mobile camera 10 is in communication with the processing device 16. Accordingly, when the mobile camera 10 is disposed to capture an image containing image data of the presentation media 14, the image data may be wirelessly communicated to the processing device. For example, in response to the mobile camera 10 being pointed at the presentation media 14 such that a portion of the presentation media that defines a field of view 18 (or camera image field) of the mobile camera 10 is captured as an image 20 capable of display at a display 22 of the mobile camera 10, the image data corresponding to the image 20 may be transmitted to the processing device 16 via a wireless communication protocol 24 such as, for example, Bluetooth. Alternatively, the image 20 may be transmitted to the processing device via a wired connection. The field of view 18 of FIG. 1 is centered on the image 20 which shows a connection pattern. In a wireless environment, once the field of view 18 captures the connection pattern as the image 20, a wireless connection is automatically made between the mobile camera 10 and the processing device 16. In a wired connection environment, the connection pattern is not necessary.

By using the mobile camera 10 in conjunction with the presentation device 12, the presentation media 14 and the processing device 16, it is possible to perform functions with respect to the image data displayed at the presentation media 14 without directly contacting the presentation device 12, the presentation media 14 or the processing device 16. For example, an object displayed in the image data may be drawn, pointed to, selected by clicking on the object, selected by dragging a selection box around the object, or otherwise manipulated. Specifically, a pointing device 26 may be inserted between the mobile camera 10 and the presentation media 14 such that the pointing device 26 is within the field of view 18 and therefore appears as a portion of the image 20 captured by the mobile camera 10. A position of the mobile camera 10 relative to the presentation media 14 is continuously updated. A position of the pointing device 26 relative to the mobile camera 10, at least with respect to a position of the pointing device 26 within the field of view 18, is also continuously updated. Accordingly, by continuously comparing the position of the mobile camera 10 relative to the presentation media 14 and the position of the pointing device 26 relative to the mobile camera 10, the position of the pointing device 26 relative to the presentation media 14 may be determined. Each of the positions described above may be communicated to the processing device 16, which then communicates the positions to the presentation device 12 for display of presentation material that is at least responsive to the pointing device 26. Alternatively, the processing device 16 may receive data from the mobile camera 10 which enables the processing device 16 to determine the positions described above.

For example, a projector (presentation device 12) may display a presentation slide having an object on a screen (presentation media 14) responsive to input from a laptop computer (processing device 16). A presenter may hold the mobile camera 10 in one hand such that the field of view 18 of the mobile camera 10 is capable of capturing at least a portion of the presentation slide. The presenter may then insert a finger (pointing device 26) of the other hand between the mobile camera 10 and the presentation slide such that the finger is in the field of view 18. In such a situation, the processing device 16 is programmed to recognize the finger as a pointing device. The laptop processes image data from the mobile camera 10 to determine a position of the finger relative to the presentation slide and continuously updates the position of the finger. The laptop communicates the continuously updated position of the finger to the projector for display as a cursor at a position of the presentation slide corresponding to the continuously updated position of the finger.

Due, in particular, to the continuous updating of the position of the mobile camera 10 relative to the presentation media 14, a mobile camera 10 instead of a fixed and calibrated camera can be used. Additionally, use of the mobile camera 10 permits multiple users, each having a corresponding mobile camera 10 to control separate cursors responsive to corresponding pointing devices 26 for display at the presentation media 14. Specifically, in a case where a single camera is used, it may be difficult to resolve image data having multiple pointing devices within a single field of view. Accordingly, by employing multiple mobile cameras 10, multiple users may each separately communicate a position of their corresponding pointing devices to the processing device 16. Thus, the position of the corresponding pointing devices will each be highly resolved since each of the pointing devices is the only pointing device being resolved in the field of view of the corresponding mobile camera 10.

The user may be either relatively close to or far from the presentation media 14 or the mobile camera 10. Limitations on distances between the mobile camera 10 and the presentation media 14 are based on a maximum or minimum distance at which the mobile camera 10 can resolve a position of the field of view 18 relative to the display 13 of the presentation media 14. In order to resolve a position of the field of view 18 relative to the display 13 of the presentation media 14, various methods may be employed. In an exemplary embodiment, the presentation media 14 is covered by or otherwise includes a number of visual elements 30. Accordingly, a minimum distance between the mobile camera 10 and the presentation media 14 may be limited by a density of the visual elements 30. In other words, if the distance between the mobile camera 10 and the presentation media 14 is not large enough to ensure at least one visual element 30 is within the field of view 18, the position of the pointing device 26 may not be able to be determined. A maximum distance between the mobile camera 10 and the presentation media 14 would be limited by resolution of the image 20 and based on properties of the mobile camera 10. In other words, if the distance between the mobile camera 10 and the presentation media 14 is so large that at least one visual element 30 within the field of view 18 cannot be resolved, the position of the pointing device 26 may not be able to be determined. Focus of the mobile camera 10 can affect both maximum and minimum distances. However, pointing with the mobile camera 10 may function properly as long as the mobile camera 10 is able to resolve at least one of the visual elements 30.

It should be noted that although the field of view 18 of FIG. 1 appears to have a larger density of visual elements 30 than the rest of the display 13, the rest of the display 13 may have the same density of visual elements 30 as that of the image 20. As such, the density of the visual elements 30, may be either relatively dense or relatively sparse.

The visual elements 30 may be dispersed, at a predetermined density, over the planar surface of the presentation media 14. The visual elements 30 may be coded such that each of the visual elements 30 is unique and corresponds to a particular location of the presentation media 14. Accordingly, when the visual elements 30 that are captured in the image 20 are recognized by the mobile camera 10, the field of view 18 may be defined relative to the display 13 of the presentation media 14. In other words, the mobile camera 10 may support an application that determines a relationship between a coordinate space of the presentation media 14, such as a canvas, and a coordinate space of a camera image field (the field of view 18). In order to ensure continuous updating of the relationship between the coordinate space of the canvas and the coordinate space of the camera image field, the relationship is determined repeatedly, typically at regular time intervals, during operation.

Concurrent with determination of the relationship between the coordinate space of the canvas and the coordinate space of the camera image field, the mobile camera 10 or the processing device 16 also determines a position of the pointing device 26 relative to the coordinate space of the camera image field. The determination of the position of the pointing device 26 relative to the coordinate space of the camera image field is also continuously updated by conducting the determination repeatedly, typically at regular time intervals. The mobile camera 10 may then determine a position of the pointing device 26 relative to the coordinate space of the canvas at a particular time based on the relationship between the coordinate space of the canvas and the coordinate space of the camera image field at the particular time and the position of the pointing device 26 relative to the coordinate space of the camera image field at the particular time. In other words, the position of the pointing device 26 is related to the coordinate space of the canvas since both the position of the pointing device 26 and the coordinate space of the canvas can be determined relative to the coordinate space of the camera image field. By repeatedly performing such determination at corresponding regular time intervals, the position of the pointing device 26 relative to the coordinate space of the canvas may be updated in a manner that appears to be continuous to an observer. When the application performing the above determinations is disposed at the mobile camera 10, data including a computer control signal may be transmitted to the processing device 16 to enable display of a cursor 27 on the presentation media 14 via the presentation device 12 at a portion of the display 13 of the presentation media 14 that corresponds to a position of the pointing device 26 relative to the field of view 18.

It should be noted that although, the immediately preceding description was described in reference to the mobile camera 10 running an application for determining positions of various elements, the application could instead be run at the processing device 16. Accordingly, both the mobile camera 10 and the processing device 16 are capable of processing for determination of the relationship between the coordinate space of the canvas and the coordinate space of the camera image field, determination of a position of the pointing device 26 relative to the coordinate space of the camera image field, and determination of the position of the pointing device 26 relative to the coordinate space of the canvas.

In an exemplary embodiment, the visual elements 30 may include coded glyphs. The coded glyphs may be, for example, a series of groups of a given number of “L” shaped characters that are dispersed over the surface of the presentation media 14. The coded glyphs may be dispersed such that each group of coded glyphs is associated with a particular location or X-Y coordinate of the presentation media 14. Accordingly, when particular coded glyphs are in the field of view 18, the field of view 18 may be defined in terms of the portion of the display 13 of the presentation media 14 that corresponds to those particular glyphs. In other words, based on the coded glyphs in the image 20, the mobile camera 10 may determine the relationship between the coordinate space of the canvas and the coordinate space of the camera image field as described above. The coded glyphs may be coded, for example, by orientation of each of the glyphs in the group, by color codes, or any other suitable means. Accordingly, the glyphs need not necessarily be “L” shaped, but may be any suitable shape.

In another exemplary embodiment, the visual elements 30 may include two dimensional bar codes. As described above for the coded glyphs, the bar codes may be dispersed over the surface of the presentation media 14 such that each of the bar codes is capable of use for defining the field of view 18 in terms of the portion of the display 13 of the presentation media 14 that corresponds as described above. Alternatively, visually recognizable data that is projected or displayed at the presentation media 14 may be used as the visual elements 30. For example, visually recognizable elements on a bar chart may be the visual elements 30. Accordingly, the mobile camera 10 may define the field of view 18 in terms of the corresponding portion of the display 13 of the presentation media 14 based on the visually recognizable elements within the image 20.

In an exemplary embodiment, the visually recognizable elements may include document text. For example, the mobile camera 10 may be used in conjunction with presentation media 14 that includes a display of text. The text may be, for example, a document such as a page of a book, a newspaper article, a treatise, etc. In such a case, the mobile camera 10 could be used to take a high resolution image of the document. The high resolution image may be optimized by ensuring textual lines appear straight such that columns of text appear as rectangles. Feature extraction may be performed on the image such that particular features are associated with particular coordinate locations of the presentation media 14. Accordingly, movement of the mobile camera 10 may be accounted for such that the mobile camera 10 or the processing device 16 may determine a relationship between a coordinate space of the document and a coordinate space of the field of view 18. The pointing device 26 may then be inserted into the field of view 18 and used as described above.

In addition to using the pointing device 26 to merely control movement of a cursor on a display, functionality such as clicking on select objects, drawing, clicking and dragging, highlighting text, etc. may be implemented. For example, the mobile camera 10 may include an application which can resolve certain finger movements or combinations of fingers to be associated with particular functions. In other words, the application can associate a visually detectable pattern, such as the finger movements or combinations of fingers, with a particular function. In an exemplary embodiment, the application, which runs on the mobile camera 10 or the processing device 16, may be capable of resolving a single finger and associating the single finger with a cursor. Accordingly, the cursor moves on the display 13, as described above, in direct correlation to the movement of the single finger. If two fingers are detected, such as an index and a middle finger, the application may associate a clicking function with a presence of the two fingers. Accordingly, if, for example, the index finger alone is extended and moved to a position of the field of view 18 corresponding to an icon on the display 13 and the middle finger is extended to be adjacent to the index finger and then retracted, the mobile camera 10 or the processing device 16 may detect and associate this action with a mouse click and the icon may be selected such that the processing device 16 performs the functions associated with selection of the respective icon. If text is displayed, the index and middle fingers may be extended to perform a click and if the index and middle fingers are subsequently moved over a portion of the text, the portion of the text will be selected as would occur with a click-and-drag of a mouse. The selected text may then be fed to an optical character recognition (OCR) system and stored on a clipboard, for example. If a thumb is extended to touch a tip of the index finger, such as to simulate a writing grip, this action may be associated with a drawing function. Accordingly, as long as only the index finger is detected, the cursor will move corresponding to the movement of the index finger. However, when the thumb is detected as being in the writing grip position relative to the index finger, a line will be drawn on the display to correspond to movement of the cursor in response to a movement of the thumb and index fingers in the writing grip position.

In order to simplify processing needed to resolve each of the fingers, a glove having different colors associated with each of the fingers may be worn and the application therefore associates each color with a particular finger. The glove may use alternative means of differentiation as well, such as, for example, a symbol associated with each of the fingers. Alternatively, colored nail polish may be used or each finger may be covered with a thimble-like device which facilitates differentiation of the fingers. In such a case, the processing device 16 may be pre-programmed to associate a particular color with a particular finger.

Due to the fact that the mobile camera 10 of the present invention need not be fixed in position, it may be advantageous to account for alignment variations between the mobile camera 10 and the planar surface of the presentation media 14. In other words, it may be advantageous to account for a case in which the image 20 does not represent a rectangle, but rather a four sided polygon with two obtuse and two acute angles. An algorithm such as that described at http://gandalf-library.sourceforge.net may be implemented under such circumstances. As described and tested with Gandalf computer vision library, an assumption may be made that the presentation media 14 is flat and the pointing device 26 lies in a plane. Then let xᵢ be a point on the image 20 and let Xᵢ be coordinates on the plane that correspond to the point on the image 20. Four points are needed to calculate a homography. The relation between the xᵢ and the Xᵢ may be described using the equation: xᵢ=λᵢPXᵢ. Using an eigenvector system, the homography of P may be determined. A resultant three-by-three matrix λP=P′ can be used in coordinate conversions using the equation: x=P′X, where x and X are coordinates in homographic form. Accordingly, a point in the image 20 x=(xₓ, x_{y}, 1) may be converted to a point on the plane X by the following conversion:
x=P′X→X=P′⁻¹x.
Therefore, X=(xₓ, x_{y}, x_{z}) is in homographic form, so the actual point on the plane is X′=(xₓ/x_{z}, x_{y}/x_{z}). Thus, the present invention may be practiced even if the mobile camera 10 is not fixed and therefore does not present a near rectangular field of view.

According to one aspect of the invention, all or a portion of the system of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

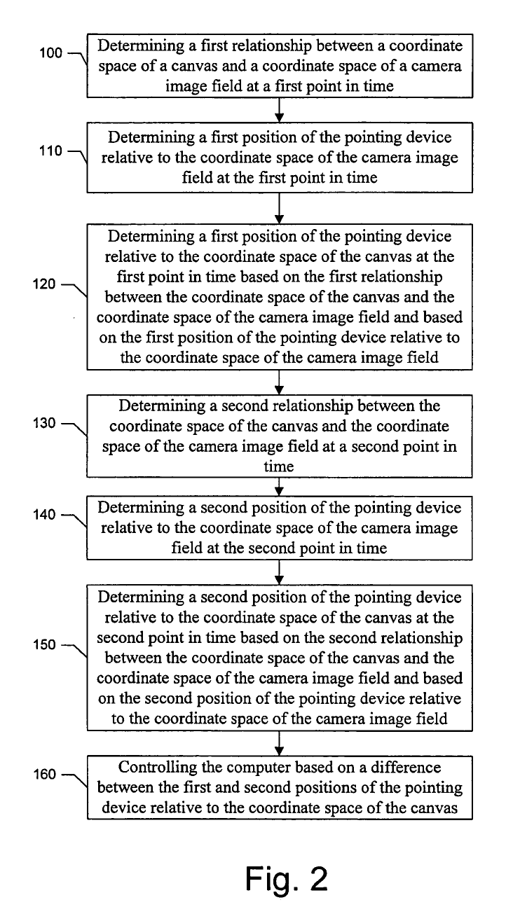

In this regard, FIG. 2 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

As shown in FIG. 2, at operation 100 a first relationship between a coordinate space of a canvas and a coordinate space of a camera image field is determined at a first point in time. At operation 110, a first position of the pointing device relative to the coordinate space of the camera image field is determined at the first point in time. A first position of the pointing device relative to the coordinate space of the canvas is determined at the first point in time based on the first relationship between the coordinate space of the canvas and the coordinate space of the camera image field and based on the first position of the pointing device relative to the coordinate space of the camera image field at operation 120. At operation 130, a second relationship between the coordinate space of the canvas and the coordinate space of the camera image field is determined at a second point in time. At operation 140, a second position of the pointing device relative to the coordinate space of the camera image field is determined at the second point in time. A second position of the pointing device relative to the coordinate space of the canvas at the second point in time is determined based on the second relationship between the coordinate space of the canvas and the coordinate space of the camera image field and based on the second position of the pointing device relative to the coordinate space of the camera image field at operation 150. At operation 160, the computer is controlled based on a difference between the first and second positions of the pointing device relative to the coordinate space of the canvas.

In an exemplary embodiment, as described above, the pointing device may be a finger. Controlling the computer may include moving a cursor on a display screen of the computer, causing a mouse click, or causing a mouse click and hold and moving the cursor. In an exemplary embodiment, a finger or, more specifically, certain combinations of fingers may be implemented to cause the above described controls. Additionally, multiple users may each use a pointing device via mobile cameras associated with corresponding ones of each of the multiple users.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for controlling a computing apparatus, the system comprising:
a mobile camera; and
a processing device,
wherein one of the mobile camera and the processing device is capable of:
determining a first relationship between a coordinate space of a media surface and a coordinate space of a camera image field at a first point in time;
determining a first position of a pointing device relative to the coordinate space of the camera image field at the first point in time;
determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field; and
controlling a computer application based on the first position of the pointing device relative to the coordinate space of the media surface.

2. The system of claim 1, wherein one of the mobile camera and the processing device is further capable of:
determining a second relationship between the coordinate space of the media surface and the coordinate space of the camera image field at a second point in time;
determining a second position of the pointing device relative to the coordinate space of the camera image field at the second point in time; and
determining a second position of the pointing device relative to the coordinate space of the media surface at the second point in time based on the second relationship between the coordinate space of the media surface and the coordinate space of the camera image field and based on the second position of the pointing device relative to the coordinate space of the camera image field; and
controlling a computer application based on a difference between the first and second positions of the pointing device relative to the coordinate space of the media surface.

3. The system of claim 2, wherein the pointing device is a human finger.

4. The system of claim 2, wherein controlling the computer application includes one of moving a cursor on a display screen of the computing apparatus, causing a mouse click, and causing a mouse click and hold and moving the cursor.

5. The system of claim 2, wherein the pointing device is a first pointing device, and wherein one of the mobile camera and the processing device is further capable of:
determining a first position of a second pointing device relative to the coordinate space of the camera image field at the first point in time; wherein the camera is further capable of determining a second position of the second pointing device relative to the coordinate space of the camera image field at the second point in time;
determining the first position of the second pointing device relative to the coordinate space of the media surface at the first point in time based on the first relationship between the coordinate space of the media surface and the coordinate space of the camera image field and based on the first position of the second pointing device relative to the coordinate space of the camera image field;
determining a second position of the second pointing device relative to the coordinate space of the media surface at the second point in time based on the second relationship between the coordinate space of the media surface and the coordinate space of the camera image field and based on the second position of the second pointing device relative to the coordinate space of the camera image field; and
transmitting a control signal based on a difference between the first and second positions of the second pointing device relative to the coordinate space of the media surface, based on a difference between first positions of the first and second pointing devices, and based on a difference between the second positions of the first and second pointing devices.

6. A mobile camera for controlling a computing apparatus, the camera comprising a processing element capable of:
determining a first relationship between a coordinate space of a media surface and a coordinate space of a camera image field at a first point in time;
determining a first position of a pointing device relative to the coordinate space of the camera image field at the first point in time;
determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field; and
controlling a computer application based on the first position of the pointing device relative to the coordinate space of the media surface.

7. The camera of claim 6, wherein one of the mobile camera and the processing device is further capable of:
determining a second relationship between the coordinate space of the media surface and the coordinate space of the camera image field at a second point in time;
determining a second position of the pointing device relative to the coordinate space of the camera image field at the second point in time; and
determining a second position of the pointing device relative to the coordinate space of the media surface at the second point in time based on the second relationship between the coordinate space of the media surface and the coordinate space of the camera image field and based on the second position of the pointing device relative to the coordinate space of the camera image field; and
controlling a computer application based on a difference between the first and second positions of the pointing device relative to the coordinate space of the media surface.

8. The camera of claim 7, wherein the pointing device is a human finger.

9. The camera of claim 7, wherein the control signal controls the computing apparatus by one of moving a cursor on a display screen of the computer, causing a mouse click, and causing a mouse click and hold and moving the cursor.

10. The camera of claim 7, wherein the pointing device is a first pointing device, and wherein the processing element is further capable of determining a first position of a second pointing device relative to the coordinate space of the camera image field at the first point in time; wherein the processing element is further capable of determining a second position of the second pointing device relative to the coordinate space of the camera image field at the second point in time;
wherein the processing element is further capable of determining a first position of the second pointing device relative to the coordinate space of the media surface at the first point in time based on the first relationship between the coordinate space of the media surface and the coordinate space of the camera image field and based on the first position of the second pointing device relative to the coordinate space of the camera image field;
wherein the processing element is further capable of determining a second position of the second pointing device relative to the coordinate space of the media surface at the second point in time based on the second relationship between the coordinate space of the media surface and the coordinate space of the camera image field and based on the second position of the second pointing device relative to the coordinate space of the camera image field; and
wherein the processing element transmits the computer control signal based on a difference between the first and second positions of the second pointing device relative to the coordinate space of the media surface, based on a difference between first positions of the first and second pointing devices, and based on a difference between the second positions of the first and second pointing devices.

11. A method of controlling a computing apparatus, the method comprising:
determining a first relationship between a coordinate space of a media surface and a coordinate space of a camera image field at a first point in time;
determining a first position of a pointing device relative to the coordinate space of the camera image field at the first point in time;
determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field; and
controlling a computer application based on the first position of the pointing device relative to the coordinate space of the media surface.

12. The method of claim 11, wherein one of the mobile camera and the processing device is further capable of:
determining a second relationship between the coordinate space of the media surface and the coordinate space of the camera image field at a second point in time;
determining a second position of the pointing device relative to the coordinate space of the camera image field at the second point in time; and
determining a second position of the pointing device relative to the coordinate space of the media surface at the second point in time based on the second relationship between the coordinate space of the media surface and the coordinate space of the camera image field and based on the second position of the pointing device relative to the coordinate space of the camera image field; and
controlling a computer application based on a difference between the first and second positions of the pointing device relative to the coordinate space of the media surface.

13. The method of claim 12, wherein the pointing device is a human finger.

14. The method of claim 12, wherein controlling the computing apparatus comprises one of moving a cursor on a display screen of the computing apparatus, causing a mouse click, and causing a mouse click and hold and moving the cursor.

15. The method of claim 12, wherein the pointing device is a first pointing device, and wherein the method further comprises:
determining a first position of a second pointing device relative to the coordinate space of the camera image field at the first point in time;
determining a second position of the second pointing device relative to the coordinate space of the camera image field at the second point in time;
determining a first position of the second pointing device relative to the coordinate space of the media surface at the first point in time based on the first relationship between the coordinate space of the media surface and the coordinate space of the camera image field and based on the first position of the second pointing device relative to the coordinate space of the camera image field;
determining a second position of the second pointing device relative to the coordinate space of the media surface at the second point in time based on the second relationship between the coordinate space of the media surface and the coordinate space of the camera image field and based on the second position of the second pointing device relative to the coordinate space of the camera image field; and
controlling the computing apparatus based on a difference between the first and second positions of the second pointing device relative to the coordinate space of the media surface, based on a difference between first positions of the first and second pointing devices, and based on a difference between the second positions of the first and second pointing devices.

16. A computer program product for using a mobile camera for controlling a computer, the computer program product comprising at least one computer-readable storage medium having computer-readable program code portions stored therein, the computer-readable program code portions comprising:
a first executable portion capable of determining a first relationship between a coordinate space of a media surface and a coordinate space of a camera image field at a first point in time;
a second executable portion capable of determining a first position of the pointing device relative to the coordinate space of the camera image field at the first point in time;
a third executable portion capable of determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field; and
a fourth executable portion capable of controlling a computer application based on the first position of the pointing device relative to the coordinate space of the media surface.

17. The computer program product of claim 16, wherein the computer-readable program code portions further comprise:
a fifth executable portion capable of determining a second relationship between the coordinate space of the media surface and the coordinate space of the camera image field at a second point in time;
a sixth executable portion capable of determining a second position of the pointing device relative to the coordinate space of the camera image field at the second point in time;
a seventh executable portion capable of determining a second position of the pointing device relative to the coordinate space of the media surface at the second point in time based on the second relationship between the coordinate space of the media surface and the coordinate space of the camera image field and based on the second position of the pointing device relative to the coordinate space of the camera image field; and
a eighth executable portion capable of controlling the computer based on a difference between the first and second positions of the pointing device relative to the coordinate space of the media surface.

18. The computer program product of claim 17, wherein the pointing device is a human finger.

19. The computer program product of claim 17, wherein the eighth executable portion controls the computer by one of moving a cursor on a display screen of the computer, causing a mouse click, and causing a mouse click and hold and moving the cursor.

20. The computer program product of claim 17, wherein the pointing device is a first pointing device, and wherein the computer program product further comprises:
an ninth executable portion capable of determining a first position of a second pointing device relative to the coordinate space of the camera image field at the first point in time;
a tenth executable portion capable of determining a second position of the second pointing device relative to the coordinate space of the camera image field at the second point in time;
a eleventh executable portion capable of determining a first position of the second pointing device relative to the coordinate space of the media surface at the first point in time based on the first relationship between the coordinate space of the media surface and the coordinate space of the camera image field and based on the first position of the second pointing device relative to the coordinate space of the camera image field;
an twelfth executable portion capable of determining a second position of the second pointing device relative to the coordinate space of the media surface at the second point in time based on the second relationship between the coordinate space of the media surface and the coordinate space of the camera image field and based on the second position of the second pointing device relative to the coordinate space of the camera image field; and
a thirteenth executable portion capable of controlling the computer based on a difference between the first and second positions of the second pointing device relative to the coordinate space of the media surface, based on a difference between first positions of the first and second pointing devices, and based on a difference between the second positions of the first and second pointing devices.

21. A processing device for controlling a computer, the device comprising a processing element capable of:
determining a first relationship between a coordinate space of a media surface and a coordinate space of a camera image field at a first point in time;
determining a first position of a pointing device relative to the coordinate space of the camera image field at the first point in time;
determining a first position of the pointing device relative to the coordinate space of the media surface at the first point in time based on the first relationship between the coordinate space of the media surface and the coordinate space of the camera image field and based on the first position of the pointing device relative to the coordinate space of the camera image field; and
controlling a computer application based on the first position of the pointing device relative to the coordinate space of the media surface.

22. The device of claim 21, wherein one of the mobile camera and the processing device is further capable of:
determining a second relationship between the coordinate space of the media surface and the coordinate space of the camera image field at a second point in time;
determining a second position of the pointing device relative to the coordinate space of the camera image field at the second point in time; and
determining a second position of the pointing device relative to the coordinate space of the media surface at the second point in time based on the second relationship between the coordinate space of the media surface and the coordinate space of the camera image field and based on the second position of the pointing device relative to the coordinate space of the camera image field; and
controlling a computer application based on a difference between the first and second positions of the pointing device relative to the coordinate space of the media surface.

23. The device of claim 22, wherein the pointing device is a human finger.

24. The device of claim 22, wherein the processing element controls the computer application by one of moving a cursor on a display screen of the computer, causing a mouse click, and causing a mouse click and hold and moving the cursor.

25. The device of claim 22, wherein the pointing device is a first pointing device, and wherein the processing element is further capable of receiving from the mobile camera a first position of a second pointing device relative to the coordinate space of the camera image field at the first point in time; wherein the processing element is further capable of receiving from the digital camera a second position of the second pointing device relative to the coordinate space of the camera image field at the second point in time;
wherein the processing element is further capable of determining a first position of the second pointing device relative to the coordinate space of the media surface at the first point in time based on the first relationship between the coordinate space of the media surface and the coordinate space of the camera image field and based on the first position of the second pointing device relative to the coordinate space of the camera image field;
wherein the processing element is further capable of determining a second position of the second pointing device relative to the coordinate space of the media surface at the second point in time based on the second relationship between the coordinate space of the media surface and the coordinate space of the camera image field and based on the second position of the second pointing device relative to the coordinate space of the camera image field; and
wherein the processing element controls the computer application based on a difference between the first and second positions of the second pointing device relative to the coordinate space of the media surface, based on a difference between first positions of the first and second pointing devices, and based on a difference between the second positions of the first and second pointing devices.
